(19) United States
(12) Patent Application Publication
(10) Pub. No.: US 2017/0344797 A1
(43) Pub. Date: Nov. 30, 2017

(54) METHOD FOR PACKAGING FINGERPRINT SENSING CHIP AND FINGERPRINT SENSING MODULE MADE USING THE SAME

(71) Applicant: SunASIC Technologies, Inc., New Taipei City (TW)

(72) Inventors: Chung Hao HSIEH, New Taipei City (TW); Zheng Ping HE, Taipei (TW); Chi Chou LIN, New Taipei City (TW)

(73) Assignee: SunASIC Technologies, Inc., New Taipei City (TW)

(21) Appl. No.: 15/599,498

(22) Filed: May 19, 2017

(30) Foreign Application Priority Data
May 26, 2016 (TW) 105116374

(51) Int. Cl. G06K 9/00; H01L 23/00; G06F 21/32; H04M 1/667; H04L 9/32

(52) U.S. Cl. CPC G06K 9/00087; H04M 1/667; H04L 9/3231; G06F 21/32; H01L 24/08; H01L 2224/02

(57) ABSTRACT

A method for packaging fingerprint sensing chips and a fingerprint sensing module using the method are disclosed. The method includes the steps of: A. providing a number of PCBs for packaging fingerprint sensing chips, wherein the PCBs are connected in a form of a panel before cutting; each PCB located in the periphery has a protruding structure on a top surface thereof; each protruding structure connects to adjacent protruding structures to form an cofferdam body; B. mounting a fingerprint sensing chip and other electronic components for each PCB to form a number of PCBAs; C. fixing the PCBAs so that the top surfaces of the fingerprint sensing chips are on the same level substantially; D. dispensing a liquid packaging material to a space enclosed by the cofferdam body; E. curing the liquid packaging material; and F. cutting the connected PCBAs and removing the protruding structure to form independent PCBAs.

### FIELD OF THE INVENTION

The present invention relates to a method for packaging fingerprint sensing chips and a fingerprint sensing module made by the method. More particularly, the present invention relates to a method for packaging fingerprint sensing chips using packaging material containing curable compositions and a fingerprint sensing module made by the method.

### BACKGROUND OF THE INVENTION

Fingerprint sensing chip is the core element the devices utilizing fingerprints for security maintenance and identity verification. With blooming applications of mobile payment service on smartphones, the fingerprint sensing chip gradually becomes a necessary element of smartphones. Therefore, in order to fulfill the requirement of compact designs for smartphones, packaging method of fingerprint sensing chips which affects the size of the final product becomes more and more important. In addition, the packaging method is also a key factor affecting the appearance and performance of the final products.

Please see FIG. 1. It shows a fingerprint sensing module 1 using a conventional packaging method. The method for packaging the fingerprint sensing module 1 is illustrated below. First, solder necessary passive components 5 to predetermined locations of a PCB 2; then, attach a fingerprint sensing chip 4 with silver adhesive 3 onto the PCB 2; next, by wire bonding, connect the bonding pad 6 of the fingerprint sensing chip 4 to corresponding contacts of PCB 2 with bonding wires 7; last, provide a layer of packaging material 8 (usually, an epoxy molding compound) by pouring to cover said elements to form a protective layer. If necessary, the thickness of the packaging material 8 can be ground to be thinner till a designed thickness.

The prior art mentioned above has defects as listed below. First, the grinding process of each fingerprint sensing module 1 requires extra cost. Second, the accuracy of grinding is affected by thickness difference of the PCB 2, flatness of the PCB, deviation in the dimension of the fixing tooling and the grinding machine. A deviation angle may exist between the top surface of the fingerprint sensing module 1 and the top surface of the fingerprint sensing chip 4 after grinding, and may be large enough to affect the performance of the fingerprint sensing module 1. Moreover, the total thickness of individual fingerprint sensing module 1 in a batch of the modules may also vary. Third, the packaging materials 8 suitable for pouring method are usually dark and opaque. It may require addition cost to customize the appearance of the module, e.g. exterior color or texture of the packaging material. Last, there is usually a layer fluoride covering the surface of the fingerprint sensing module to prevent residues of a user's finger from remaining on the fingerprint sensing module. The residues may cause security problems, such as false accepted authentication, or a latent fingerprint on the fingerprint sensor. Meanwhile, forming of the fluoride is a special process and cannot be carried out by mixing with the packaging material 8 and utilizing density difference. It hinders the cost reduction of the fingerprint sensing module 1.

Hence, an innovative fingerprint sensing chip packaging method to settle the problems mentioned above is desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to settle the problems mentioned above, a method for packaging fingerprint sensing chips is disclosed. The method includes the steps of: A. providing a plurality of PCBs (Printed Circuit Boards) for packaging fingerprint sensing chips, wherein the PCBs are connected in the form of a panel before cutting; each PCB located in the periphery has a protruding structure on a top surface thereof; each protruding structure connects to adjacent protruding structures so that a cofferdam body is formed; B. mounting a fingerprint sensing chip and other electronic components for each PCB to form a plurality of PCBAs (Printed Circuit Board Assemblies); C. fixing the PCBAs so that the top surfaces of the fingerprint sensing chips are on the same level substantially; D. dispensing a liquid packaging material to a space enclosed by the cofferdam body to cover the mounted fingerprint sensing chips and other electronic components; E. curing the liquid packaging material; and F. cutting the connected PCBAs and removing the protruding structure to form independent PCBAs.

Preferably, the method further may include a step E1 after step E: E1. forming a hydrophobic and oleophobic fluoride layer over the cured packaging material. Step C may include sub-steps: C1. placing the PCBAs in the form of a panel into a tooling so that bottom surfaces of the PCBAs and a portion of the tooling forming a space; and C2. applying an air pressure to the space, wherein the air pressure is lower than the pressure above the PCBAs.

According to the present invention, curing in step E may be light curing, thermal curing or naturally curing after a long period. The liquid packaging material may be further mixed with a hydrophobic and oleophobic fluoride before dispensing, so that the hydrophobic and oleophobic fluoride is able to float up to the surface of the liquid packaging material by density difference after dispensing and before the liquid packaging material being cured. The hydrophobic and oleophobic fluoride may be perfluoroalkyl methacrylic acid copolymer or fluorinated silica nanoparticle. The packaging material may have a component of epoxy, silicone, acrylic or a mixture thereof. The packaging material may also have a component of a hardener for hardening the packaging layer. Or, the packaging material may have a component of coloring agent. At least one side of the PCB having the protruding structure is longer than a corresponding side of the PCB without the protruding structure. Each PCB having the protruding structure has a shape the same as that of the PCB without the protruding structure after cutting the protruding structure.

Another aspect of the present invention is a fingerprint sensing module. The fingerprint sensing module includes: a PCBA; a fingerprint sensing chip, mounted on the PCBA; and a packaging layer, covering a top surface of the fingerprint sensing chip and a portion of a top surface of the PCBA. The PCBA is used to operate the fingerprint sensing chip. The packaging layer has no grinding marks on the top surface.

According to the present invention, the fingerprint sensing module may further have a hydrophobic and oleophobic fluoride layer over the packaging layer. The packaging layer may have a component of epoxy, silicone, acrylic or a mixture thereof. The packaging layer may also have a component of a hardener for hardening other components. The packaging layer may further have a component of coloring agent.

The method for packaging fingerprint sensing chips provided by the present invention doesn't need to have a grinding process. Comparing with conventional techniques, it saves lots of costs. All parts in the manufactured fingerprint sensing module have smaller relative difference after fixing process. Each formed fingerprint sensing module after cutting have similar electronic performance. Meanwhile, with the present invention, the fingerprint sensing module after packaging can have diverse colors in appearance with the coloring agent. There are many ways to form the fluoride layer.

### BRIEF DESCRIPTION OF THE DRAWINGS

FIG. 1 shows a fingerprint sensing module manufactured by a conventional packaging method.

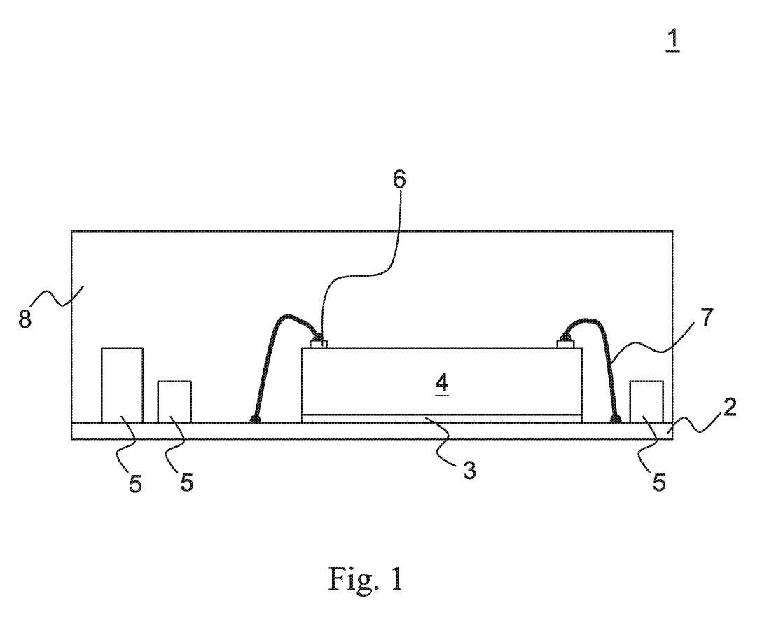

FIG. 2 is a flowchart of the procedure of a method for packaging fingerprint sensing chips disclosed in the present invention.

FIG. 3 is a top view of 16 PCBs forming a panel.

FIG. 4 is a top view of the PCBs mounted with fingerprint sensing chips and other electronic components.

FIG. 5 is a cross-sectional view along an AA′ line in FIG. 4.

FIG. 6 shows a panel of connected PCBAs been placed into a tooling with a pressure difference exerted on it.

FIG. 7 shows a panel of connected PCBAs been fixed into a tooling with a pressure difference exerted on it to ensure flatness of the panel.

FIG. 8 shows forming of a fluoride layer.

FIG. 9 is a cross-sectional view of a fingerprint sensing module made according to said method.

FIG. 10 shows an aspect of the packaging material being cured.

FIG. 11 shows another aspect of the packaging material being cured.

### DETAILED DESCRIPTION OF THE PREFERRED EMBODIMENTS

The present invention will now be described more specifically with reference to the following embodiments.

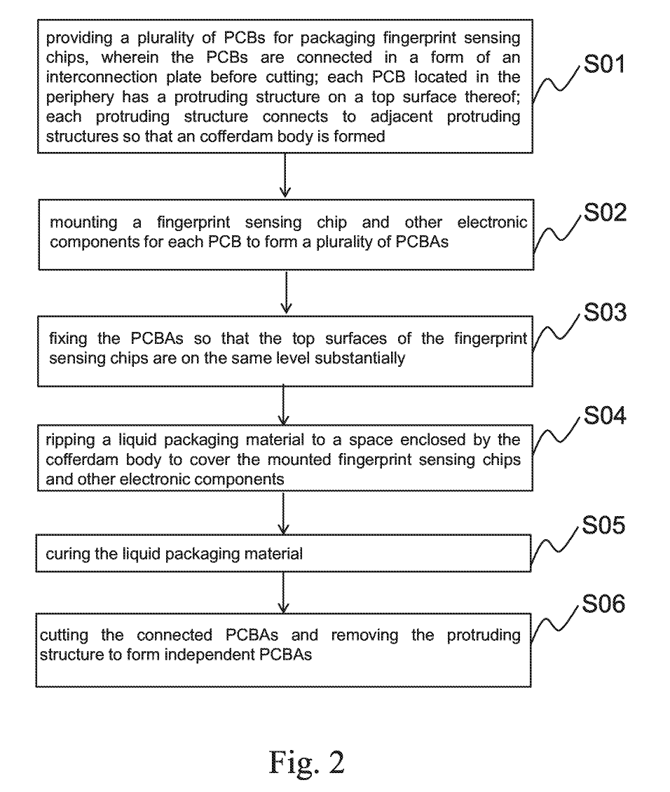

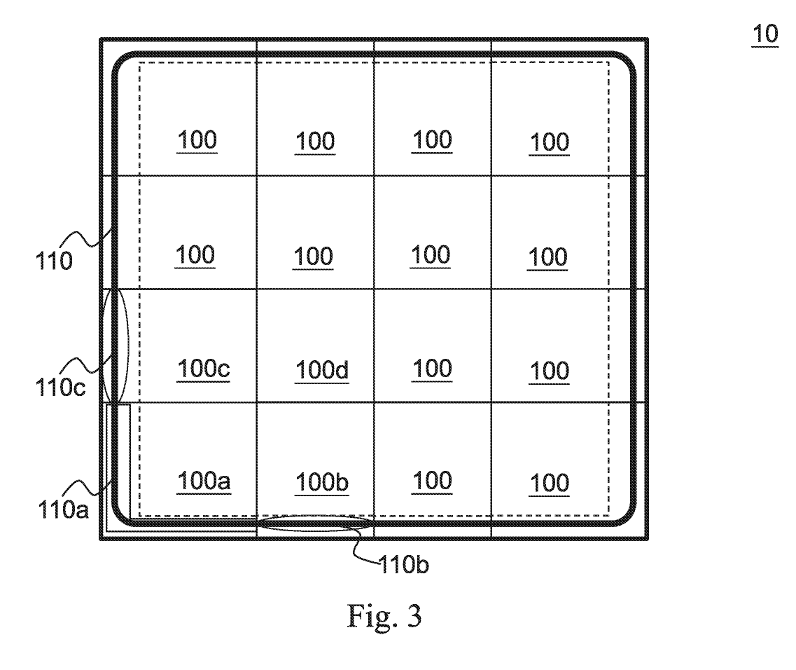

Please refer to FIG. 2. It is a flow chart of a method for packaging fingerprint sensing chips disclosed in the present invention. The method includes several steps. In order to have a comprehensive understanding of the spirit of the present invention, please refer to figures from FIG. 3 to FIG. 9 synchronously.

A first step of the present method is to provide a number of PCBs 100 for packaging fingerprint sensing chips 130. The PCBs 100 are connected in the form of a panel. Each PCB 100 located in the periphery has a protruding structure on its top surface, and protruding structure is perpendicular to the top surface. The protruding structure is similar to a dam bar structure. Each protruding structure connects to adjacent protruding structures so that a cofferdam body 110 is formed (S01). Please see FIG. 3. It is a top view of 16 PCBs forming a panel. As to techniques of PCB, to reduce the manufacturing cost of individual PCBs, several PCBs will be grouped onto a larger board—the panel (for illustration purpose, all PCBs 100 under the connected condition mentioned below are replaced by a panel 10). The divider (spacing between the boards) between two PCBs 100 is a V-shaped groove and the width of it is not shown. After the electronic components are mounted and packaging is completed for the PCBs, individual PCBs are separated from the panel by cutting or breaking along the V-shape grooves. In the present embodiment, the panel 10 includes 16 PCBs 100. According to the spirit of the present invention, the number of the PCBs 100 is not limited to 16. It can be any number. In order to have a further description, Specific names are given to those PCBs 100 having different characteristics, e.g. a first PCB 100a, a second PCB 100b, a third PCB 100c and a fourth PCB 100d.

In FIG. 3, the V-shaped grooves between PCBs are depicted by fine straights (with respect to the boundary of the panel 10). However, in case there are lacerations in the cofferdam body 110 due to the existence of V-shaped grooves, it is better not to form V-shaped groove below the cofferdam body 110. Of course, in consideration of precision cutting the panel 10 by machine, the V-shaped grooves may not be formed. The PCBs 100 located in the periphery are the 12 PCBs 100 that the cofferdam body 110 crosses (including the first PCB 100a, the second PCB 100b and the third PCB 100c). Those PCBs 100 all have a protruding structure on their top surface, and all protruding structures together form the cofferdam body 110. Shapes of the protruding structures may not be the same. For example, the first PCB 100a has a first protruding structure 110a. The first protruding structure 110a is marked by an L-shaped frame. A top-viewed shape of the first protruding structure 110a is an “L”. The second PCB 100b has a second protruding structure 110b. The second protruding structure 110b is marked by an oval frame. A top-viewed shape of the second protruding structure 110b is a long horizontal rod. The third PCB 100c has a third protruding structure 110c. The third protruding structure 110c is marked by an oval frame. A top-viewed shape of the third protruding structure 110c is a long vertical rod. Other protruding structures on the PCBs 100 located in the periphery have one of the three shapes. However, the top-viewed shape of the protruding structure is not limited to the three styles depicted in FIG. 3. As long as all protruding structures can form an enclosed cofferdam body 110 (functions and further criteria of the cofferdam body 110 will be illustrated later), the top-viewed shape can be any shape, e.g. oval, astroid, polygon, or even arbitrary shape.

It should be emphasized that at least one side of the PCBs 100 having the protruding structure is longer than a corresponding side of the PCBs 100 without the protruding structure. For example, the length of the second PCB 100b is longer than that of the fourth PCB 100d; the width of the third PCB 100c is longer than that of the fourth PCB 100d; both the length and width of the first PCB 100a are longer than the length and width of the fourth PCB 100d, respectively. The cofferdam body 110 itself is formed by some later processes manufacturing the panel 10.

Considering the consistency of final fingerprint sensing modules in mass production, the final dimensions of the PCBs 100 should be the dimensions of the inner PCBs 100 (in the present embodiment, they are the 4 PCBs 100 around the center, including the fourth PCB 100d). Hence, the PCBs 100 located in the periphery should be cropped into the same size as the inner ones after main packaging processes are finished. Cutting lines are shown by the dashed frame in FIG. 3. Looking into the dashed frame, all PCBs 100 have the same size. It should be emphasized that FIG. 3 shows only for illustration. Its aspect ratio may be different from what is used in practice. It doesn't have the intent to limit the application of the present invention.

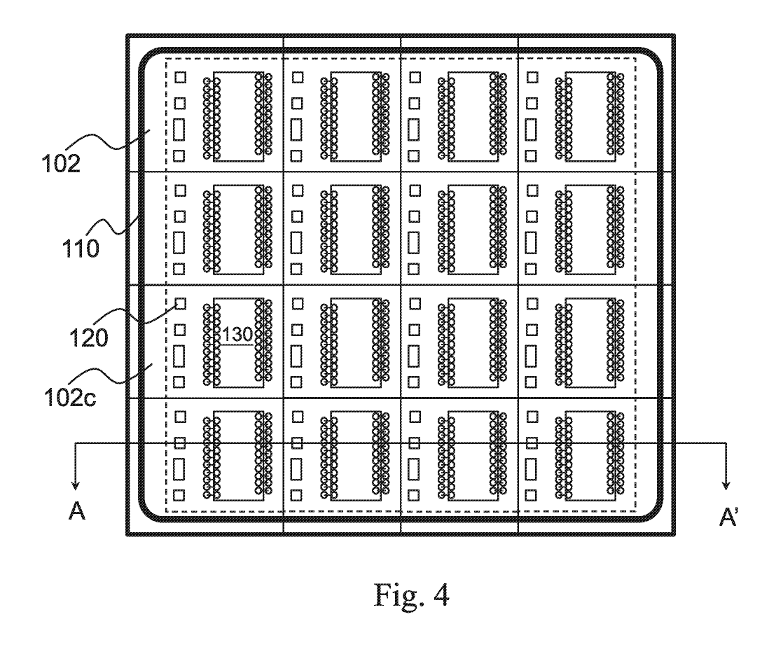

The second step of the method disclosed in the present invention is mounting a fingerprint sensing chip 130 and other electronic components 120 for each PCB 100 to form a number of PCBAs 102 (S02). Please see FIG. 4. It is a top view of the PCBs 100 mounted with fingerprint sensing chips 130 and other electronic components 120. The so-called “other electronic component 120” includes active and passive components to maintain normal operation of the fingerprint sensing chip 130. Those who in the art of manufacturing the fingerprint sensing module should be familiar with these electronic components. No more detailed description about the electronic components is disclosed by the present invention. However, all electronic components 120 are like the fingerprint sensing chip 130 that the way they are mounted closely relates to their I/O design. The mounting processes may be adhering by silver adhesive first then bonding wire. It can also be direct soldering, e.g. surface mounting. According to the design of the fingerprint sensing module, there might be different processes. After step S02 is finished, there is a PCBA 102 formed on each PCB 100. For example, the third PCB 100 has a third PCBA 102c formed thereon.

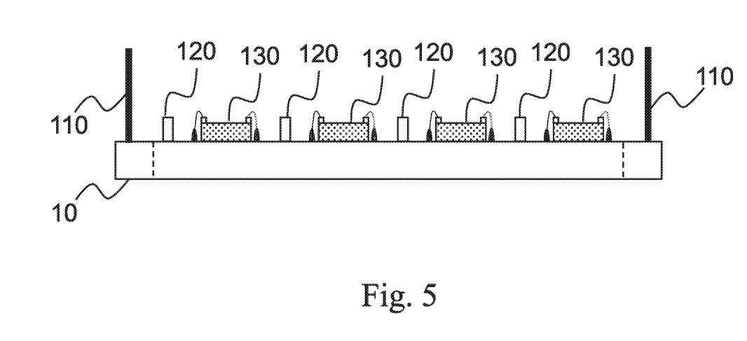

Then, fix the PCBAs 102 so that the top surfaces of the fingerprint sensing chips 130 are on the same level substantially (S03). In order to further explain this point, a cross-sectional view is along an AA′ line in FIG. 4 and perpendicular to the paper is given as an example. Please see FIG. 5. It should be pointed out that in the cross-sectional view, the cofferdam body 110 (or each protruding structure) is protruded from and perpendicular to the top surface of the PCB 100. The level of the top of the cofferdam body 110 is higher than a highest level among the fingerprint sensing chip 130, other electronic components 120 or the top of the bonding wire. The top surfaces of the fingerprint sensing chips 130 substantially located on the same level can ensure similar sensibility for every fingerprint sensing module after the fingerprint sensing chip is sealed into the module. However, manufacturing of panel 10 and connection with the fingerprint sensing chips 130 and other electronic components 120 have a slight difference. This slight difference is a certain small-but-unavoidable amount of random error introduced by every step of the manufacturing process, and the largest difference comes from bending of panel 10. If the bottoms of the PCBAs 102 (namely, the bottoms of the PCBs 100; for the present invention, it is better that all electronic components can be mounted on one side of the PCB 100) is fixed in a flat plane, said difference could be reduced. Surfaces of the fingerprint sensing chips 130 can be located at the same level.

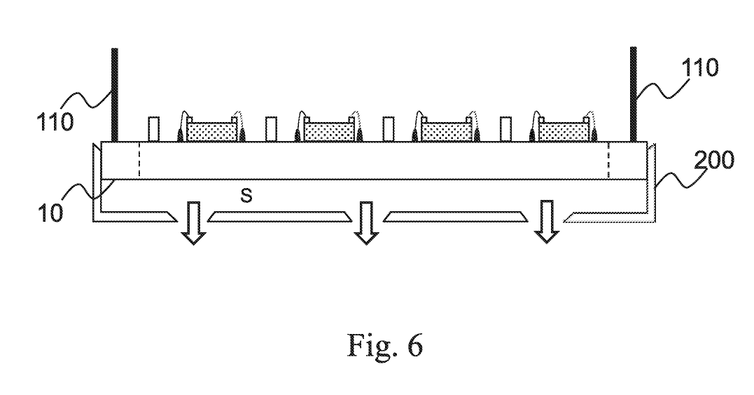

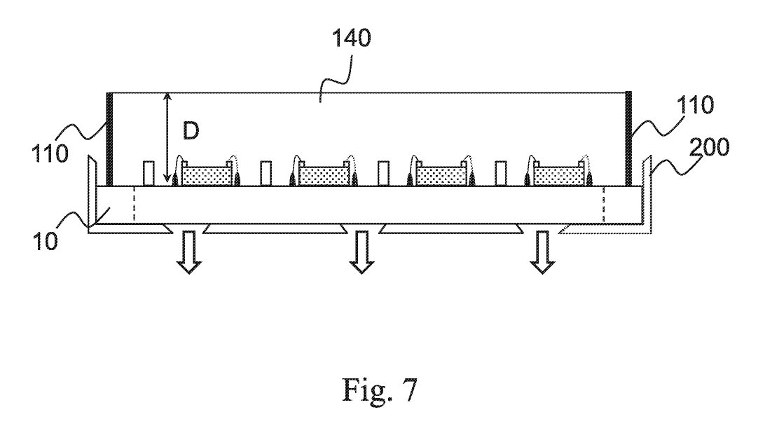

Please see FIG. 6. According to the present invention, the way mentioned for fixing is to place the PCBAs 102 connected in the form of a panel into a tooling 200 so that bottom surfaces of the PCBAs 102 and a portion of the tooling forms a space and apply an air pressure to the space, wherein the air pressure is lower than the pressure above the PCBAs 102. Due to the pressure difference, the bottoms of the PCBAs 102 can be contacted with the bottom of the tooling 200 as closely as possible (Please see FIG. 7). The tooling 200 is a fixture with a flat top surface and the space may be a plurality of small cavities for air (gas) to flow across. As long as the bottom of the tooling 200 is level, the surfaces of the fingerprint sensing chips 130 are level. It helps for coming steps. It should be emphasized that the tooling 200 in the embodiment is open, namely, the top surfaces of the connected PCBAs 102 are exposed to atmospheric pressure. If the tooling 200 is placed in a chamber with sub-atmospheric pressure, the same effect can be achieved. In practice, the tooling 200 can be designed with a closed space. Under this situation, the atmospheric pressure can be changed to any gas pressure to control flatness of the bottoms of the PCBAs 102.

Then, dispense a liquid packaging material 140 to a space enclosed by the cofferdam body 110 to cover the mounted fingerprint sensing chips 130 and other electronic components 120 (S04). The component of the liquid packaging material 140 may contain epoxy, silicone, acrylic or a mixture of said materials. A good example is polyurethane epoxy resin. The packaging material 140 is different from the molding compound used in conventional fingerprint sensing chip packaging for thermal pouring. The packaging material 140 used by the present invention must be liquid with low viscosity at packaging stage. With the low viscosity of the packaging material 140, all components on the panel 10 can be completely covered without any gap. Meanwhile, when the packaging material 140 stops flowing, the top surface of the packaging material 140 is level and is parallel to top surfaces of every fingerprint sensing chips 130 because of the gravity. The goal of consistent sensibility for each fingerprint sensing module after the packaging process can be achieved. After dispensed, the packaging material 140 should be better to have a protective thickness D higher than the highest level of the components under its surface for providing protection for the electronic components 120 and the fingerprint sensing chips 130. The protective thickness D should be at least larger than 25 μm. Preferably, it is between 25 μm and 75 μm. According to the developed technologies nowadays, the quantity of fluids packaging material 140 dispensed into the space of the cofferdam body 110 can be precisely controlled by precision quantitative dispensing or micro-dispensing. As to mass production, although there are differences between panels 10 of different batches (and associated PCBAs 102 as well), the variation of the protective thickness D above for each PCBA 102 in each batch is very small. The variation of the total volume caused be the differences is very small compared with the space below the surface of packaging material 140 in the cofferdam body 110. When the precision quantitative dispensing applies, it can be ensured that the protective thicknesses D above the PCBA 102 in each batch are almost the same. Furthermore, each fingerprint sensing module after packaging can have identical electric performance.

Unlike conventional packaging materials for fingerprint sensing chips or ICs which are commonly black or dark colors, the packaging material 140 in the present invention can be translucent or transparent. In addition, the packaging material 140 can also be mixed with coloring agents. Thus, the appearance of fingerprint sensing module may have a plurality of choices, e.g. different colors and different transparency. Since the transparent material is processed by dispensing, the quantity of the coloring agent depends on requirement. In contrast, conventionally, if the packaging material needs to use non-regular color (not black), a large quantity of coloring agent is needed and costly. Final color in appearance is limited to a range of tones (usually dark).

The next step of the method is curing the liquid packaging material 140 (S05). The curing method depending on different materials may be light curing, e.g. applying UV light, or thermal curing. The packaging material 140 may also have components of hardeners. And the curing process may be done at room temperature.

In the present embodiment, the last step of the method of the present invention is depaneling, a process separating each PCBAs 102 from the panel 10 and cutting off the protruding structure to form independent PCBAs 102 (S06). The depaneling method may be punching, V-score cutting, milling, break-routing, sawing, laser cutting, or hand breaking. Now, separated PCBAs 102 can have identical functions, similar sensibility and the same size. In other words, each PCB 100 having the protruding structure has the same appearance as that of the PCBs 100 without the protruding structure after its protruding structure is removed.

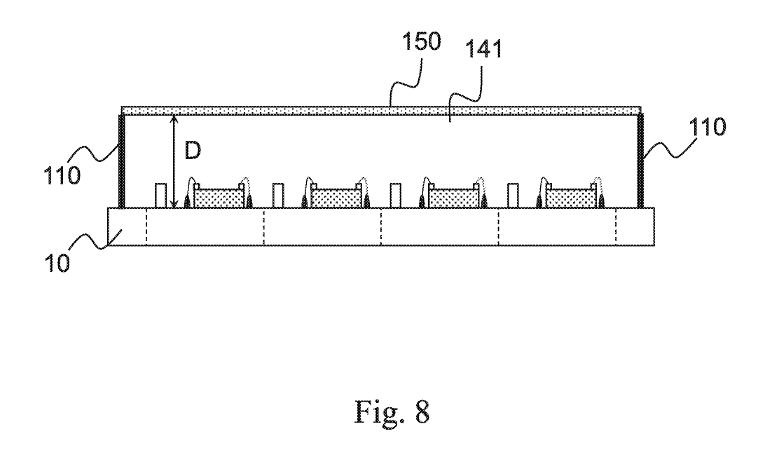

It should be emphasized that, according to the spirit of the present invention, the fingerprint sensing module after packaging may further having a top layer of hydrophobic and oleophobic material, which prevents residues, e.g. the sebum secretion and skin moisture of a touching finger, from sticking to the fingerprint sensing module. The hydrophobic and oleophobic material may be a material containing fluorides, such as perfluoroalkyl methacrylic acid copolymer or fluorinated silica nanoparticle. Hence, in another embodiment, after step S05 and before S06, there is a step S05′: S05′ forming a hydrophobic and oleophobic fluoride layer 150 over the cured packaging material 140. A cross-sectional view after the fluoride layer 150 been formed is shown in FIG. 8. The step S05′ above is a specific process for forming the fluoride layer 150. However, the fluoride layer 150 may be formed spontaneously. For example, the liquid packaging material 140 may be further mixed with a low specific gravity, hydrophobic and oleophobic fluoride before dispensing, so that the hydrophobic and oleophobic fluoride is able to float up to the surface of the liquid packaging material 140 by density difference after dispensing and before the curing process. After a period of time, the fluoride layer 150 is naturally formed.

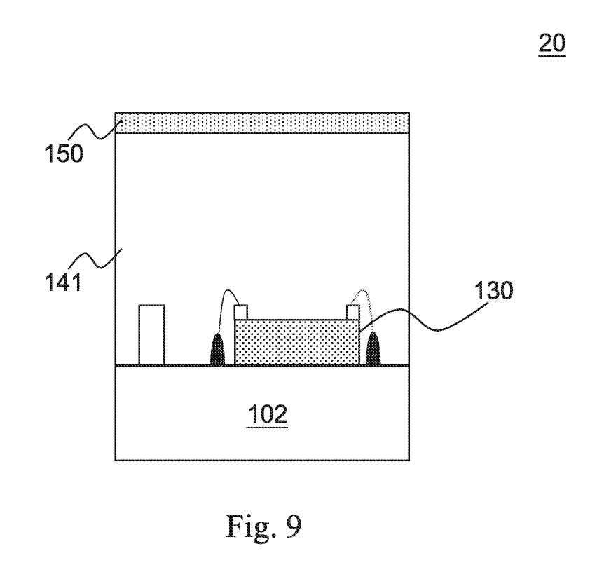

A fingerprint sensing module 20 manufactured according to said method is shown in FIG. 9. The fingerprint sensing module 20 mainly includes: a PCBA 102, a fingerprint sensing chip 130, a packaging layer 141 and a hydrophobic and oleophobic fluoride layer 150. The fingerprint sensing chip 130 is mounted on the PCBA 102. The packaging layer 141 covers the top surface of the fingerprint sensing chip 130 and a portion of the top surface of the PCBA 102. The PCBA 102 is used to operate the fingerprint sensing chip 130. Since there is no grinding process on the packaging layer 141 to get the desired thickness, a difference between the PCBA 102 and general fingerprint sensing modules after packaging is that there are no grinding marks on the top surface of the packaging layer 141. Thus, there is no issue from grinding.

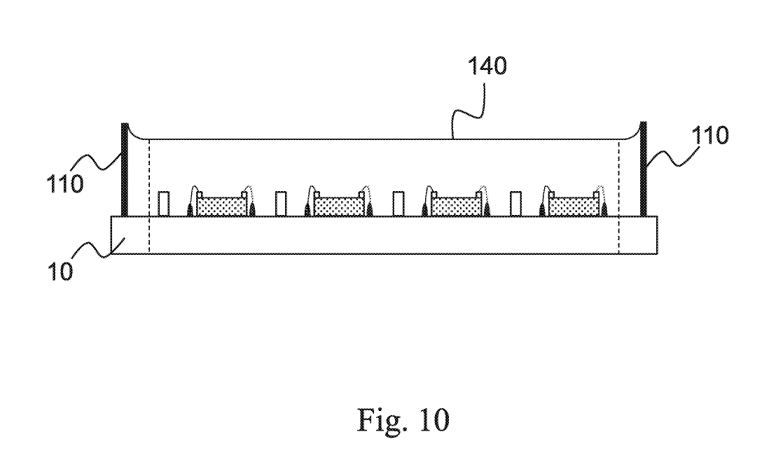

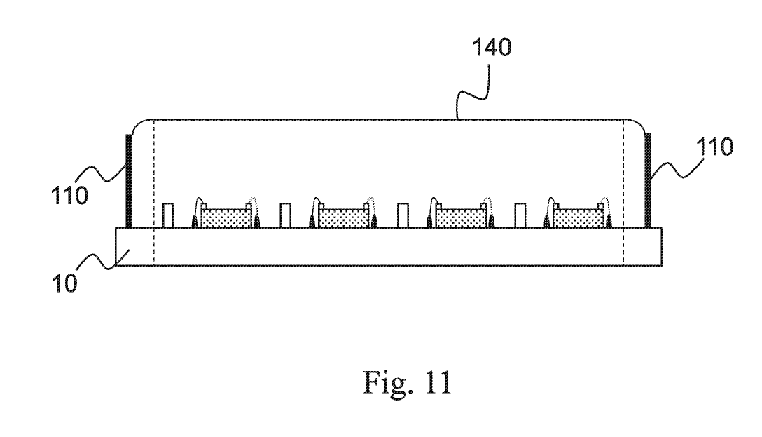

Last, when the packaging material 140 used in the present invention in the liquid state, due to different surface tensions among air-liquid interface air-cofferdam interface, and liquid-cofferdam interface, a contact angle greater or less than 90 degree may be formed wherever the two surfaces meet. As shown in FIG. 10, the interface is a concave surface. However, as shown in FIG. 11, the interface is a convex surface. Hence, when choosing the packaging material 140, it is necessary to consider a range the surface may form. It should be away from the dashed frame in FIG. 3. Thus, a final cut fingerprint sensing module 20 will have a flat top surface.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for packaging fingerprint sensing chips, comprising the steps of:
A. providing a plurality of PCBs (Printed Circuit Boards) for packaging fingerprint sensing chips, wherein the PCBs are connected in a form of panel; each PCB located in the periphery of the panel has a protruding structure on a top surface thereof; each protruding structure connects to adjacent protruding structures so that a cofferdam body is formed;
B. mounting a fingerprint sensing chip and other electronic components for each PCB to form a plurality of PCBAs (Printed Circuit Board Assemblies);
C. fixing the PCBAs so that the top surfaces of the fingerprint sensing chips are on the same level substantially;
D. dispensing a liquid packaging material to a space enclosed by the cofferdam body to cover the mounted fingerprint sensing chips and other electronic components;
E. curing the liquid packaging material; and
F. cutting the connected PCBAs and removing the protruding structure to form independent PCBAs.

2. The method according to claim 1, further comprising a step E1 after step E: E1. forming a hydrophobic and oleophobic fluoride layer over the cured packaging material.

3. The method according to claim 2, wherein the hydrophobic and oleophobic fluoride is perfluoroalkyl methacrylic acid copolymer or fluorinated silica nanoparticle.

4. The method according to claim 1, wherein step C comprises sub-steps of:
C1. placing the PCBAs in the form of a panel into a tooling so that bottom surfaces of the PCBAs and a portion of the tooling forming a space; and
C2. applying an air pressure to the space, wherein the air pressure is lower than the pressure above the PCBAs.

5. The method according to claim 1, wherein curing in step E is light curing, thermal curing or room temperature curing.

6. The method according to claim 1, wherein the liquid packaging material is further mixed with a hydrophobic and oleophobic fluoride before dispensing, so that the hydrophobic and oleophobic fluoride is able to float up to the surface of the liquid packaging material by density difference after dispensing and before the liquid packaging material being cured.

7. The method according to claim 1, wherein the packaging material has a component of epoxy, silicone, acrylic or a mixture thereof.

8. The method according to claim 7, wherein the packaging material has a component of a hardener.

9. The method according to claim 7, wherein the packaging material has a component of coloring agent.

10. The method according to claim 1, wherein at least one side of the PCB having the protruding structure is longer than a corresponding side of the PCB without the protruding structure.

11. The method according to claim 10, wherein each PCB having the protruding structure has a shape the same as that of the PCB without the protruding structure after the protruding structure is removed.

12. A fingerprint sensing module, comprising:
a PCBA;
a fingerprint sensing chip, mounted on the PCBA; and
a packaging layer, covering a top surface of the fingerprint sensing chip and a portion of a top surface of the PCBA,
wherein the PCBA is used to operate the fingerprint sensing chip; the packaging layer has no grinding marks on the top surface.

13. The fingerprint sensing module according to claim 12, further comprising a hydrophobic and oleophobic fluoride layer over the packaging layer.

14. The fingerprint sensing module according to claim 12, wherein the packaging layer has a component of epoxy, silicone, acrylic or a mixture thereof.

15. The fingerprint sensing module according to claim 14, wherein the packaging layer has a component of a hardener for hardening the packaging layer.

16. The fingerprint sensing module according to claim 14, wherein the packaging layer has a component of coloring agent.
